(19) United States
(12) Patent Application Publication
(10) Pub. No.: US 2004/0151237 A1
(43) Pub. Date: Aug. 5, 2004

(54) Satellite communications system

(75) Inventors: Chester Ferry, Pleasant Grove, UT (US); Woody A. Chea, Olathe, KS (US)

Correspondence Address: Pillsbury Winthrop LLP, P.O. Box 10550, McLean, VA, 22102, US

(73) Assignee: BitRage, Inc., St. Augustine, FL

(21) Appl. No.: 10/747,102

(22) Filed: Dec. 30, 2003

Related U.S. Application Data
(63) Continuation of application No. 09/583,911, filed on May 31, 2000.

(51) Int. Cl. H04B 1/38

(52) U.S. Cl. 375/219

(57) ABSTRACT

Provided is a system and method for removing the effects of phase and amplitude distortions from data signals having at least a third order signal level in a North American Digital Signal Hierarchy. The reconstituted signals are directly modulated onto a radio frequency carrier signal using phase shit keying modulation techniques and then wirelessly transmitted via a transmitter. Further, the wirelessly transmitted reconstituted data signals are received by a corresponding receiver using a squaring loop carrier recovery operation.

### BACKGROUND OF THE INVENTION

1. Field of the Invention

This invention generally relates to the field of communications. More particularly, the present invention relates to a communications device configured to wirelessly transmit and receive high-rate digital mode signals.

2. Description of Related Art

Advances in computer capabilities as well as the unprecedented growth of Internet-related transactions, have placed great demands on conventional communication infrastructures to convey information to subscribers at higher transmission rates, with increased reliability, and using an increasing variety of transmission links. Although conventional infrastructures communicate at higher transmission rates, such as DS-3 (e.g., 45 Mbps) and OC-3 (e.g., 155 Mbps), between networked hubs, they are generally limited in their ability to accommodate such ample transmission rates between the hubs and subscribers. Such limitations arise from their inability to compensate for degradations encountered over conventional transmission media spanning distances of up to 18,000 ft. between the hubs and subscribers.

Consider, for example, how common carriers provide connectivity to subscribers. Typically, carrier hubs or central offices (COs) connect to subscribers via subscriber loop circuits. Subscriber loop circuits generally comprise 2-wire transmission paths (i.e., unshielded twister pairs—UTP), which support direct current signals, low frequency (<200 Hz) analog signals, and voice band signals (200 Hz-3.4 KHz). This range of frequencies limits the transmission rate at which digitally-encoded signals can be conveyed by the 2-wire transmission paths. Moreover, the longer the distances traversed by the signals on these 2-wire transmission paths, the more severe the degradation of the signals, thereby relegating communications to lower transmission rates. This assumes, of course, that the signals are pristine at inception; degraded signals may be subject to even lesser speeds.

Recent efforts have sought to increase the digital transmission rates conveyed by the 2-wire transmission paths. These efforts have not, however, managed to shift the use of these higher rate digitally encoded signals to other transmission media accommodating other types of transmissions, such as, for example, wireless transmissions. Existing communications systems and infrastructure are unable to correct the effects of the distortion and degradation that such transmission media imposes on these type of signals. In particular, certain high data rate signals (e.g. DS3, OC3) may be incapable of being transmitted over wireless links because by the time the signals arrive at the receive side of a wireless link, signal quality may be too degraded to be usable.

### SUMMARY OF THE INVENTION

As a result, there is a need for an apparatus capable of receiving degraded high-rate data signals, reconstituting the data signals, and directly modulating the reconstituted signals onto a carrier signal for wireless transmission over longer distances than would otherwise be possible using conventional methods.

Consistent with the principles of the present invention as embodied and broadly described herein, an exemplary embodiment includes an apparatus generating an improved data transmission signal operating at a predetermined transmission rate, thus permitting the signal to be wirelessly transmitted and received. The apparatus includes a processing unit configured to receive data signals as an input, remove effects of phase and amplitude distortions from the input, thereby producing reconstituted data signals, and provide the reconstituted data signals as an output. The apparatus further includes a transmitter electrically coupled to the processor and configured to receive and then wirelessly transmit the reconstituted data signals output from the processing unit.

### BRIEF DESCRIPTION OF THE DRAWINGS

The accompanying drawings, which are incorporated in and constitute a part of this Specification, illustrate an embodiment of the invention and, together with the description, explain the objects, advantages, and principles of the invention. In the drawings:

FIG. 1 is a functional block diagram depicting a communications system in accordance with an embodiment of the present invention.

FIG. 2 is a functional block diagram depicting a transceiver in accordance with an embodiment of the present invention.

FIG. 3 is a functional block diagram illustrating the ability of a processor to correct the effects of signal distortion in accordance with an embodiment of the present invention.

FIG. 4 is a functional block diagram illustrating the transmitter of the transceiver in accordance with an embodiment of the present invention.

FIG. 5 is a functional block diagram illustrating the receiver of the transceiver in accordance with an embodiment of the present invention.

FIG. 6 is a functional block diagram illustrating the demodulator portion of the receiver in accordance with an embodiment of the present invention.

### DETAILED DESCRIPTION OF THE PREFERRED EMBODIMENTS

The following detailed description of the present invention refers to the accompanying drawings that illustrate exemplary embodiments consistent with this invention. Other embodiments are possible and modifications may be made to the embodiments without departing from the spirit and scope of the invention. Therefore, the following detailed description is not meant to limit the invention. Rather the scope of the invention is defined by the appended claims.

It will be apparent to one of ordinary skill in the art that the present invention, as described below, may be implemented in many different embodiments of software, firmware, and hardware in the entities illustrated in the figures. The actual software code or specialized control hardware used to implement the present invention is not limiting of the present invention. Thus, the operation and behavior of the present invention will be described with the understanding that modification and variations of the embodiments are possible, given the level of detail present herein.

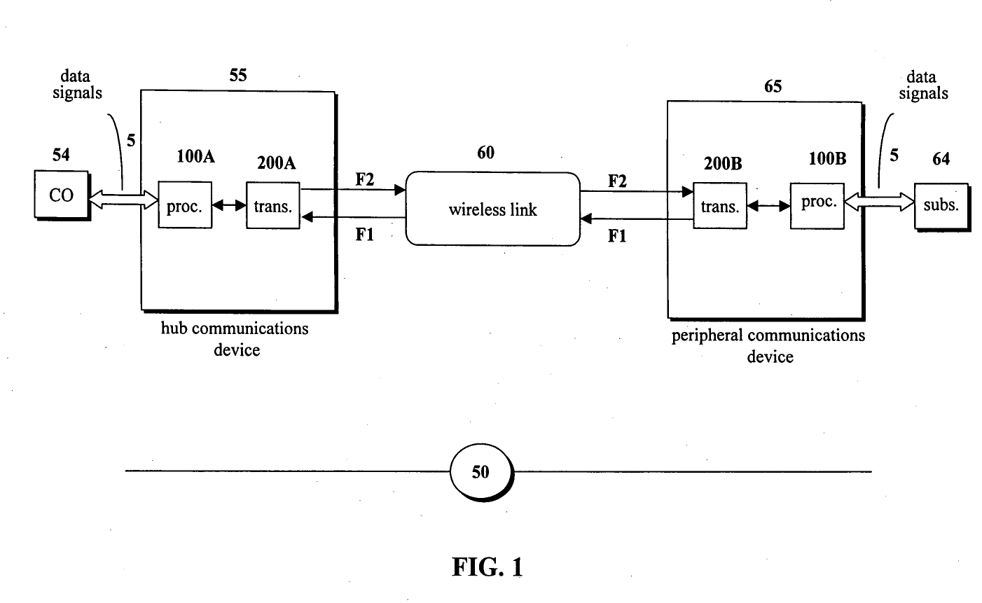

FIG. 1 illustrates communications system 50 which is constructed and operative in accordance with an embodiment of the present invention. As indicated in FIG. 1, communications system 50 includes a hub communications device 55, located at a central office location (CO) 54 and a peripheral communications device 65 at a subscriber location 64. The central office and subscriber may be, e.g., 10,000-50,000 feet apart. Communications system 50 is configured to exchange data transmission signals 5 via a wireless link 60 between the central office 54 and the subscriber 64.

It will be appreciated that data transmission signals 5 may include, for example, any high order level information-bearing (baseband) signals (i.e., third-order level or higher), as defined by the North American Digital Signal hierarchy. The North American Digital Signal Hierarchy defines third-order level signals (DS3), for example, as being pulse code modulated (PCM) signals, having a data rate of at least 45 Mb/s. Moreover, each of these third-order level signals may be configured to include 672 voice channels and utilize a binary N zero substitution (BNZS) line encoding.

As known in the art, signal distortions may result from a variety of causes. These causes could include attenuation or fading, phase delay, noise, or other similar signaling anomalies. Additionally, the effect of these anomalies may result, in particular, in distortion of phase and amplitude characteristics of the high-order level signal received by an embodiment of the present invention. In order to compensate for these anomalies, communications devices 55, 65, respectively, include processors 100A and 100B, which are electrically coupled to respective transceivers 200A and 200B. Each processor 100A, 100B is configured to receive a distorted high order level signal as an input, reconstitute the signal to remove the effects of signaling anomalies, and provide the reconstituted signal as an output. Processors 100A, 100B are electrically coupled to transceivers 200A, 200B, respectively. As such, the outputs of processors 100A, 100B are respectively provided as inputs to transceivers 200A, 200B for transmission across wireless link 60. In the specific embodiment illustrated herein, processor 100 comprises a communications processor as disclosed in the commonly-assigned copending application filed on even date herewith in the name of Woody A. Chea, entitled “Dual Stage Communication Processor,” the content of which is hereby expressly incorporated herein in its entirety.

After transceiver 200A receives the reconstituted data signal from processor 100A, transceiver 200A then transmits the reconstituted data signal across wireless link 60 at a predetermined radio frequency (RF) F2. Correspondingly, transceiver 200B of peripheral communications device 65, receives the signal transmitted across wireless link 60 at the predetermined frequency F2. Similarly, transceiver 200B transmits the reconstituted data signal received from processor 100B across wireless 60 at a predetermined transmit frequency F1 and transceiver 200A receives the transmitted signal on frequency F1. In an exemplary embodiment of the present invention, F1 may be within a range of 5.725 GHz-5.825 GHz and F2 may be within the range of 5.250 GHz-5.350 GHz. Such a separation between transmit and receive frequencies of communications devices 55 and 65, provides the capability for a full duplex data exchange, enabling each of the communications devices 55 and 65 to transmit and receive simultaneously.

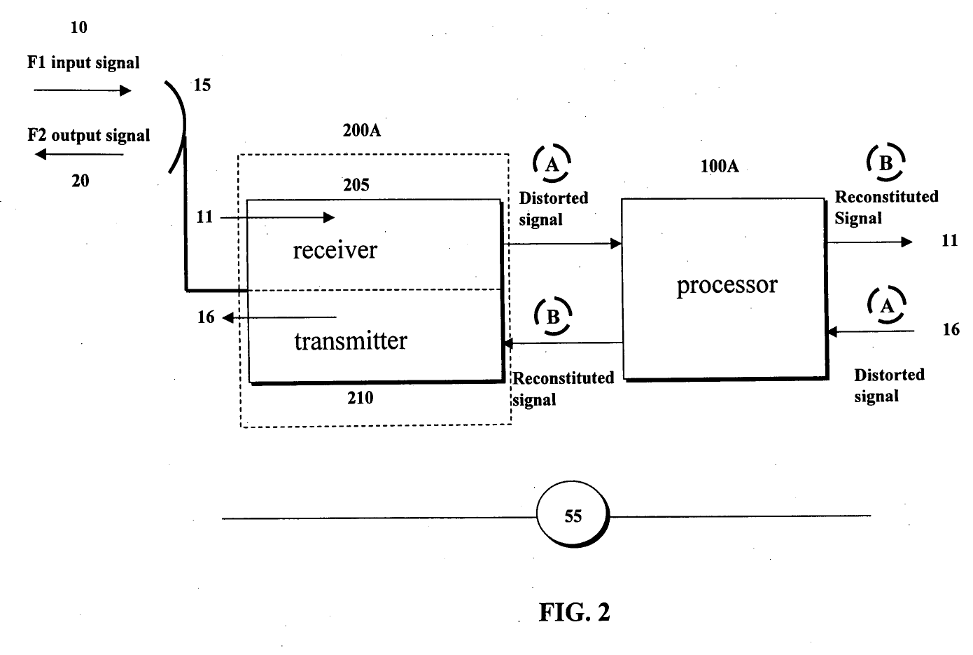

FIG. 2 illustrates an exemplary configuration of the hub communications device 55. Because peripheral communications device 65 differs from device 55 in respective receive and transmit frequencies, only the configuration of peripheral communications device 55 will be discussed in depth. As shown in FIG. 2, input signal 10 at frequency F1 is received by transceiver 200A along a receive path 11. Transceiver 200A includes an antenna 15 for initially detecting input signal F1 and a receiver 205, electrically coupled to antenna 15, for receiving the input signal 10. The receiver 205, among other things, down converts, amplifies, and demodulates the input signal 10. Additional details of the receiver will be discussed below.

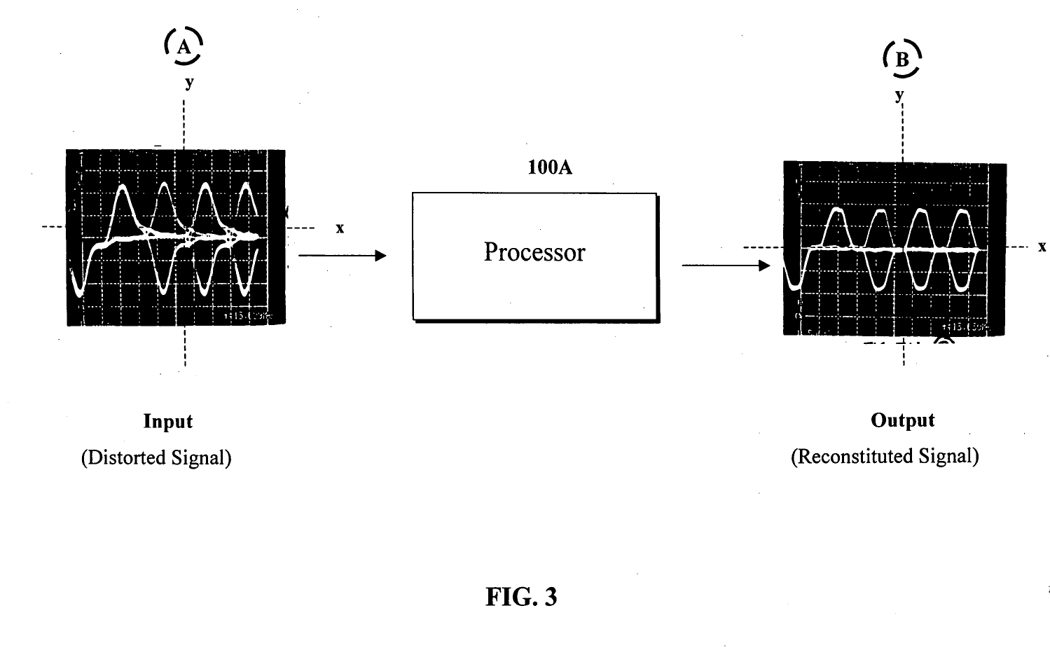

Input signal 10 by virtue of its wireless transmission via wireless link 60, may be distorted and is provided as an output of receiver 205 in the form of distorted signal A. Distorted signal A is supplied as an input to processor 100A to compensate for the effects of phase and amplitude distortions experienced by distorted signal A. As illustrated, in FIG. 3, before processing by processor 100A, distorted signal A reflects degraded amplitude characteristics along a vertical axis y, and degraded phase characteristics along horizontal axis x. After processing by the processor 100A, reconstituted signal B, reflects the removal of amplitude and phase distortions along the respective y and x axes. The ability of processor 100 to compensate for amplitude and phase distortions and reconstitute the signals, such as signal B, provides the present system with the capability to transmit third-order level signals or higher, across the wireless link 60.

Returning to FIG. 2, processor 100A receives a distorted signal A along a transmit path 16. After being input to processor 100A, and having had corrections made in phase and amplitude characteristics, a reconstituted signal B is produced at the output of processor 100A, and thus provided as an input to transmitter 210. The transmitter 210, among other things, modulates, amplifies, and outputs the reconstituted signal to antenna 15. As indicated in FIG. 1, antenna 15 propagates the reconstituted signal as an output signal in the form of an output signal 15 at RF frequency F2 across wireless link 60.

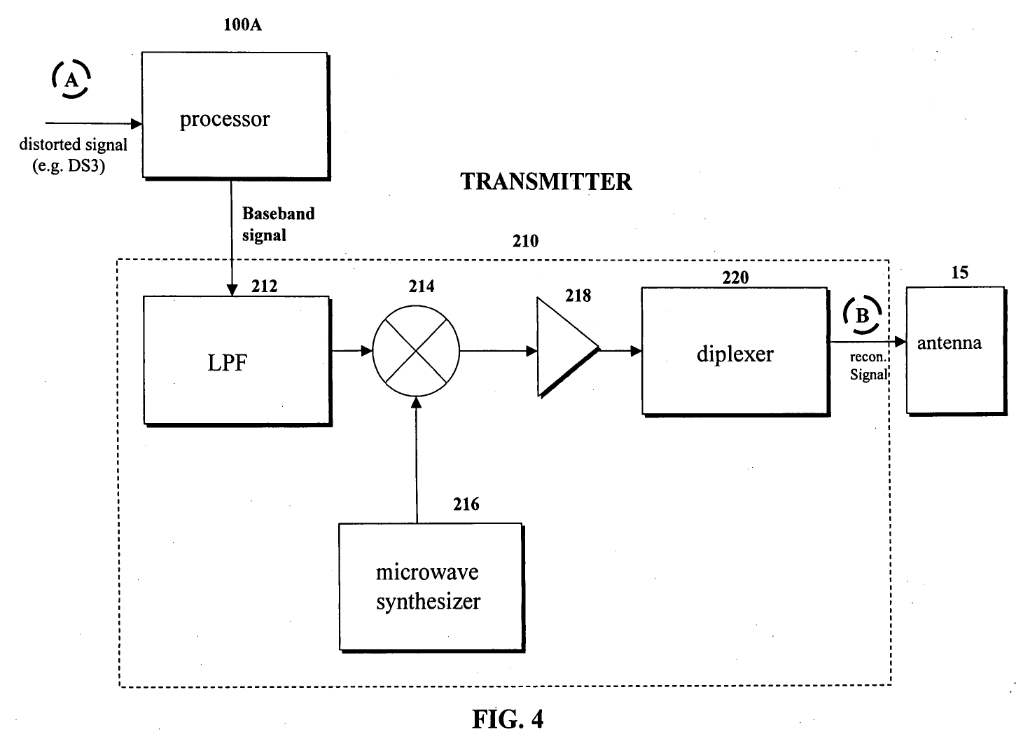

FIG. 4 illustrates an exemplary embodiment of transmitter 210. Transmitter 210 includes a filter 212, an up-conversion and modulation circuit 214, a microwave synthesizer 216, amplifier 218, and a diplexer 220. As a matter of review, high order level baseband signals, such as third-order, or DS3 signals are digitally encoded prior to transmission. That is, though the signals may contain analog information, such as voice data, the signal are converted into an equivalent digital mode format for transmission purposes. One such format is PCM. By converting an analog signal to PCM, the information represented by the signal is less prone to noise and error, and will ultimately result in a transmission having greater fidelity. Greater fidelity is provided because the digital mode PCM may combine a high number of data channels that can be transmitted at higher data rates. These PCM or baseband signals, however, do not have properties which permit them to be transmitted across a wireless link without additional processing. Therefore, in order to be transmitted, especially over a wireless link, additional processing is necessary to transmit the baseband signals and correct the effects of distortions that occur as a result of transmission.

As indicated in FIG. 1, processor 100 furnishes a reconstituted signal to filter 212 of transmitter 210. By way of illustration, this reconstituted signal may comprise a DS3 signal. DS3 signals consist of multiple data voice channels which are combined to produce a baseband signal having a data rate of approximately 45 Mb/s. This data rate translates to approximately a 45 MHz bandwidth requirement in order to be able to adequately recover the information from the DS3 signal. Additionally, the DS3 signal, while having a base, or fundamental frequency of approximately 45 MHz, generates harmonic frequencies. Harmonic frequencies are lower powered signals that are integer multiples of the fundamental frequency and are generated as by-products of the fundamental frequency. In the present case, the harmonics would be integer multiples of the approximately 45 Hz baseband signal, equating to signals at approximately 90 Hz (1^{st} harmonic), 135 Hz (3^{rd} harmonic), 180 Hz (4^{th} harmonic), etc. The signal processor 100A provides a reconstituted baseband DS3 signal and these associated harmonics, as an input to filter 212 of the transmitter 210. Filter 212, e.g., may be configured as a conventional low-pass filter which acts to remove these harmonics, and any other undesirable high frequency components, without distorting the signal pulses. This filtering ultimately brings the bandwidth of the original baseband signal to within 100 MHz as required by the Federal Communications Commission (FCC).

The up-conversion modulation circuit 214 is electrically coupled to the filter 212. Now that the reconstituted baseband signal, input to the filter 212, has been substantially stripped of undesirable, or spurious, frequency components, it may be modulated onto a carrier frequency signal. Modulation onto a carrier frequency signal permits information in the baseband signal of approximately 45 MHz, to be wirelessly transmitted. The present invention permits the digital mode signals, such as DS3, to be modulated directly onto a carrier frequency signal without first being up-converted. Modulation is accomplished by mixing the baseband signal with a carrier frequency signal produced by the microwave synthesizer 216. In the exemplary embodiment of FIG. 4, the modulator 214 is a commercially available double balanced mixer that produces a carrier frequency signal in the range of 5.25 GHz to 5.350 GHz.

A modulation technique widely used in PCM systems is phase shift keying (PSK). PSK is also used in the exemplary embodiment of the present system, binary PSK (BPSK) in particular. BPSK is used in the present invention, other acceptable PSK techniques may be used, such as quadrature PSK (QPSK), 8-PSK, etc. The PCM baseband transmission of the DS3 signal is composed of a string of analog pulses. Specifically, the DS3 signal is composed of consecutive 8-bit pulse words, each bit representing a level of information in the signal. In accordance with PSK principles, the carrier frequency signal produced by the microwave synthesizer 216, when mixed with the DS3 signal by mixer 214, is shifted in phase, in accordance with the signal levels of the DS3 signal. Mixer 214 thereby produces as an output, a modulated carrier signal in the frequency range of 5.25 GHz to 5.30 GHz, which includes the reconstituted the DS3 signal as a baseband signal.

Amplifier 218 is electrically coupled to mixer 214. The output of the mixer 214 is supplied to the amplifier 218, which is a multistage, e.g., two stage, amplifier circuit. The multistage 218 circuit is used to provide higher gain with more linear operation, e.g., to avoid spectral re-growth. The amplifiers in amplifier 218 may be class A amps operating in a very linear range. The output of the amplifier 214 is input to the diplexer 220, which in turn outputs the signal, having the reconstituted baseband signal, to the antenna 15 for transmission at a frequency in the range of 5.225-5.325 GHz, or approximately 5.301 GHz. The diplexer may include, for example, two bandpass filters which act as directional filters or signal routers. In an exemplary embodiment, the transmitted signal, is then received by a corresponding transceiver 200B.

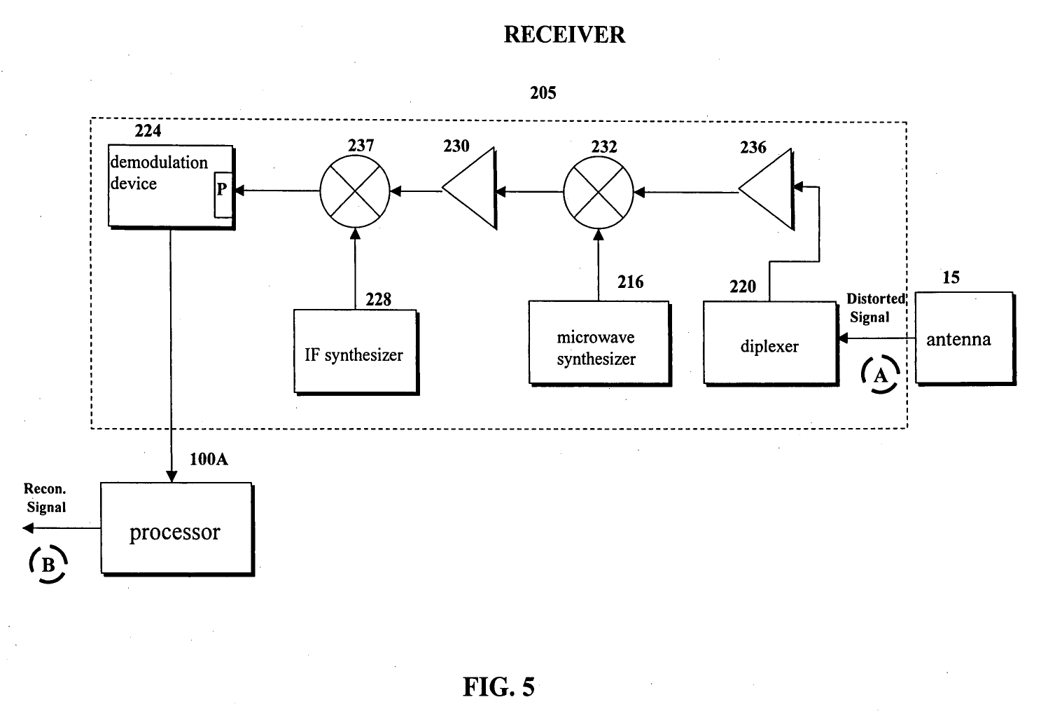

FIG. 5 shows receiver 205 of a transceiver 200A. Receiver 205 includes diplexer 220 coupled to amplifier 236. Amplifier 236 is in turn coupled to a first down-converter 232. The first down-converter 232 is coupled to both the microwave synthesizer 216 and a second amplifier 230. The microwave synthesizer 216 is the same synthesizer used in the transmitter 210. Finally, amplifier 230 is coupled to a second down-converter 237 and an IF synthesizer 228. The second down-converter has an output coupled to an input P of a demodulator device 224.

Diplexer 220 receives from the antenna 15 a carrier signal having a distorted baseband DS3 signal and provides the signal as an input to the first amplifier 236. In this case, the received RF signal is in the range of 5.725 GHz-5.825 GHz. Amplifier 236 receives the output of the diplexer 220. Amplifier 236 circuit may be a commercially available low noise amplifier (LNA), which is a multistage amplification circuit, providing a level of amplification with little added noise. The output of the amplifier 236 is fed to a first down converter 232, which is a double balanced mixer that works to down convert the signal. In the exemplary embodiment of the present invention, the double balanced mixer receives a signal from the microwave synthesizer 216 into one port, previously shown to be roughly 5.301 GHz, and into the other port, the incoming carrier frequency signal with a frequency of roughly 5.775 GHz, into its other port. The down-converter 232, as is characteristic of double balanced mixers, produces as an output, a sum of the two inputs, and the difference of the two inputs. In the present case, a difference of the two signals is selected, thus providing as an input to second amplifier 230, an intermediate frequency signal having a frequency of approximately 474 MHz.

Second amplifier 230 is an automatic gain control (AGC) circuit. Second amplifier 230, using the AGC circuit, improves the strength of an input signal by maintaining levels of the output signal at an approximately constant level regardless of the input levels of the signal. Thus, amplifier 230 is capable of performing dynamic gain. The output of the AGC circuit is fed into a second down converter circuit 237, which is also a double balanced mixer, and is coupled to an IF synthesizer. The second down-conversion circuit 237 down converts the 474 MHz signal to a second IF frequency signal having a frequency of 159 MHz. The final step, before removing the baseband signal from the carrier signal, is demodulation.

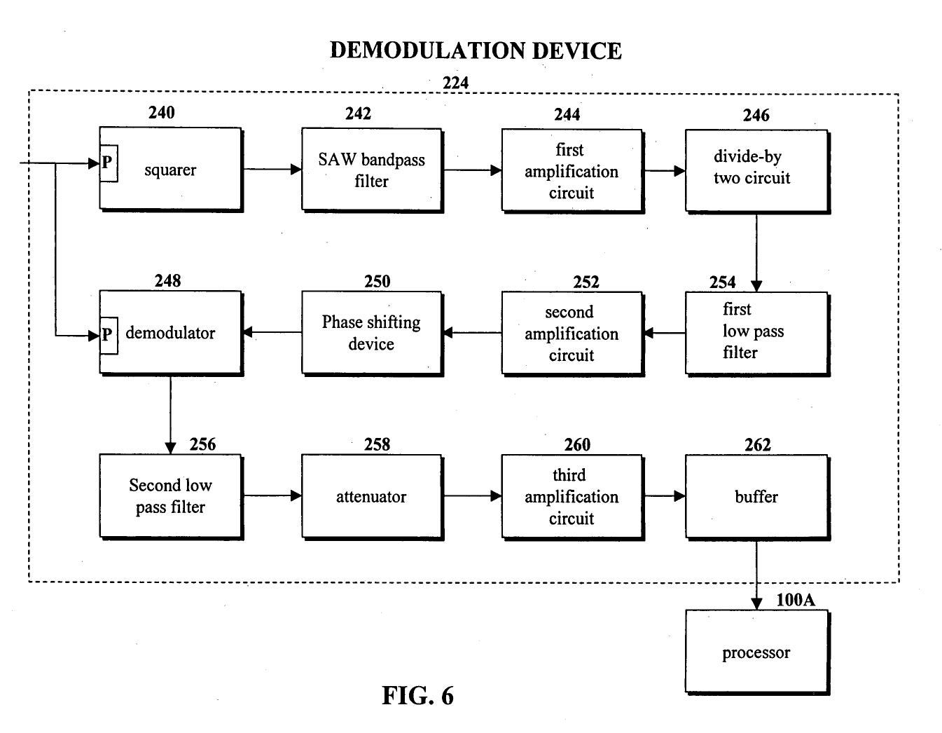

FIG. 6 shows an expanded view of an exemplary demodulation device 224, used in the present invention. The demodulation device 224 receives the output P of the down-conversion circuit 237 into input ports P of a squarer 240 and a demodulator 248. Receiver 205 uses a coherent PSK detector/squaring loop operation to recover the carrier from the modulated PSK signal. This special step is necessary because a multi-phase modulated carrier signal, as produced in the present invention using BPSK modulation, does not have true carrier signal energy. Thus, in order to detect the carrier, the receiver must locally generate an exact replica carrier signal in terms of frequency and phase, for use as a reference signal. This reference signal is then compared with the actual input signal, provided as an input to demodulator 248, in order to recover the carrier signal with the correct phase and amplitude.

Therefore, in order to remove the modulation and recover the correct carrier signal, the distorted DS3 IF signal, received from down-conversion circuit 237, is input into port P of the modulator 240. The input is then squared. This squaring process generates harmonics, of which the even numbered harmonics are devoid of modulation. Next, a bandpass filter 242 is used to select only the second super harmonic frequency signal from among the harmonics produced by the squaring operation, which although has no modulation, is at twice the frequency of the original frequency, or 318 MHz. In an exemplary embodiment of the present invention, the filter 242 is a surface acoustic wave (SAW) filter. A SAW filter is desirable because of the inherent desirable pass band characteristics of SAW filters such as linear phase and a rectangular response. The output of SAW filter 242 circuit is input into a first amplification circuit 244 for amplification.

Next, divide-by two circuit 246 is provided to return the frequency from 318 MHz to the correct frequency of 159 MHz. The output of circuit 246 is provided to a low pass filter 254. The output of low pass filter 254 is a phase coherent carrier signal that is used to isolate the DS3 information in the demodulation.

The output of the low pass filter 254 is fed into a second amplification circuit 252, which amplifies the signal and outputs it to a phase shifter 250. Phase shifter 250 shifts the phase of the recovered carrier signal by approximately 100 degrees. Under ideal conditions, a 90 degree phase shit would provide for maximum amplitude of the recovered carrier signal. The phase shifted signal is then used as a reference by a demodulator 248 (which is a double-balance mixer) to demodulate the signal output by the second down conversion circuit 237. Thus, the demodulation of the DS3 signal is performed by using a very clean and strong reference recovered carrier signal phase that has been phase shifted to remove as many phase and amplitude errors as possible.

The output of the demodulator 248 is the baseband DS3 pulses, which are fed into a second low pass filter circuit 256 to remove any residual carrier signal components and provides a limit to noise bandwidth. The output of the second low pass filter 256 is fed into an attenuator 258 for amplification and impedance matching. The output of the attenuator is then fed into a third amplification circuit 260 then to a buffer 262 for impedance matching so as to output the signal onto a 75 ohm coaxial cable via a transformer.

The foregoing description of the preferred embodiments provides an illustration and description, but is not intended to be exhaustive or to limit the invention to the precise form disclosed. Modifications and variations are possible consistent with the above teachings or may be acquired from practice of the invention. Thus, it is noted that the scope of the invention is defined by the claims and their equivalents.

What is claimed is:

1. A system comprising:
a processing unit configured to (i) receive data signals as an input, (ii) remove effects of phase and amplitude distortions from the input, in order to produce reconstituted data signals, and (iii) provide the reconstituted data signals as an output; and
a transmitter electrically coupled to the processing unit and configured to receive and then wirelessly transmit the reconstituted data signals output from the processing unit.

2. The system of claim 1, further comprising a transceiver, wherein the transmitter is part of the transceiver.

3. The system of claim 1, wherein the amplitude and phase distortions result from a particular wireless transmission.

4. The system of claim 2, wherein the transmitter comprises:
a filter configured to receive a high frequency baseband signal as an input, the filter reducing a bandwidth of the high frequency baseband signal, in order to produce a bandwidth limited signal;
a signal generator configured to produce a radio frequency signal; and
an up-converting circuit electrically coupling the filter to the signal generator, (ii) the up-converting circuit being configured to (i) receive the bandwidth limited signal as a first input and the radio frequency signal as a second input and (ii) directly modulate the bandwidth limited signal onto the radio frequency signal to produce as an output a modulated carrier signal.

5. The system of claim 4, wherein the up-converting circuit includes a modulator configured for phase shift key modulation.

6. The system of claim 2, wherein the transceiver includes a receiver, the receiver comprising:
a first signal generator configured to produce a radio frequency signal as an output;
a first down-converting circuit electrically coupled to the first generator circuit and configured to (i) receive as a first input a modulated carrier signal and receive as a second input the radio frequency signal and (ii) produce as an output a modulated signal having a first intermediate frequency;
a second signal generator configured to produce a second intermediate frequency signal as an output;
a second down-converting circuit electrically coupled to the first down-converting circuit and the second signal generator, the second down-converting circuit being configured to (i) receive as a first input the modulated signal having a first intermediate frequency and receive as a second input the second intermediate frequency signal and (ii) produce as an output a modulated signal having a third intermediate frequency; and
a demodulator configured to receive as an input the modulated signal having the third intermediate frequency and produce as an output a high frequency baseband signal.

7. The system of claim 6, wherein the demodulator comprises:
a squaring device configured to (i) receive as an input the modulated signal having the third intermediate frequency, (ii) perform a squaring process on the received modulated signal having the third intermediate frequency, the squaring process doubling a frequency of the received modulated signal having the third intermediate frequency, in order to recover a phase coherent frequency carrier signal from the received modulated signal having the third intermediate frequency, and (iii) provide the recovered phase coherent frequency carrier signal as an output;
a dividing mechanism electrically coupled to the squaring device, the dividing mechanism configured to receive the output of the squaring device and divide the output by two to produce a recovered carrier frequency signal having the third intermediate frequency as an output;
a phase shifting mechanism electrically coupled to the dividing mechanism and configured to receive the recovered carrier frequency signal having the third intermediate frequency and shift the phase thereof by a predetermined amount, the phase shifting mechanism producing as an output a phase-shifted recovered carrier signal; and
a demodulating mechanism electrically coupled to the phase shifting mechanism and to the modulator, the demodulating mechanism configured to (i) receive as a first input the modulated signal having the third intermediate frequency and receive as a second input the phase shifted recovered carrier signal, (ii) comparing the first and second inputs, and (iii) producing as an output a high frequency baseband signal, the high frequency baseband signal being based upon the comparison.

8. The system of claim 7, wherein the filter is a surface acoustic wave filter.

9. The system of claim 1, wherein each data signal has at least a third order signal level in a North American Digital Signal Hierarchy.

10. The system of claim 9, wherein the reconstituted data signals are transmitted for distances of up to 50,000 feet.

11. A system comprising:
first and second transceivers configured to cooperatively exchange data signals via a wireless communications link, each transceiver receiving a data signal during an exchange, wherein the exchange introduces phase and amplitude distortions in each received data signal; and
first and second processors electrically coupled to the first and second transceivers, each processor being respectively coupled to one of the first and second transceivers and configured to receive as an input the data signal received by the respective transceiver, wherein the first and second processors remove the phase and amplitude distortions from the data signal.

12. The system of claim 11, wherein each data signal has at least a third order signal level in a North American Digital Signal Hierarchy.

13. The system of claim 12, wherein the transceiver directly modulates each data signal onto a carrier frequency signal prior to a particular wireless exchange.

14. A method comprising:
receiving data signals having at least a third order signal level in a North American Digital Signal Hierarchy;
removing effects of phase and amplitude distortions from the received data signals in order to produce reconstituted data signals;
processing the reconstituted data signals; and
wirelessly transmitting the processed reconstituted data signals.

15. The method of claim 14, wherein the processing of the reconstituted data signals includes:
filtering the reconstituted data signals, the filtering reducing a bandwidth of the reconstituted data signals to produce a bandwidth limited signal; and
modulating the bandwidth limited signal onto a radio frequency carrier signal to produce a modulated carrier signal.

16. The method of claim 15, wherein the modulating of the bandwidth limited signal includes a phase shift keying technique.

17. The method of claim 14 comprising:
receiving a modulated carrier signal;
generating a radio frequency signal;
combining the modulated carrier signal and the radio frequency signal to produce a modulated signal having a first intermediate frequency;
generating a second intermediate frequency signal;
combining the modulated signal having the first intermediate frequency and the second intermediate frequency signal to produce a modulated signal having a third intermediate frequency; and
demodulating the modulated signal having the third intermediate frequency signal.

18. The method of claim 17, wherein the demodulating includes:
receiving the modulated signal having the third intermediate frequency;
squaring the received modulated signal having the third intermediate frequency in order to double a frequency of the received modulated signal and recover a phase coherent frequency carrier signal from the received modulated signal;
dividing the recovered phase coherent frequency carrier signal by two in order to produce a recovered carrier frequency signal having the third intermediate frequency;
shifting a phase of the recovered carrier frequency signal having the third intermediate frequency by a predetermined amount in order to produce a phase shifted recovered carrier signal; and
combining the phase shifted recovered carrier signal and the modulated signal having the third intermediate frequency in order to produce a baseband data signal.
